(19) United States
(12) Patent Application Publication
(10) Pub. No.: US 2005/0171906 A1
(43) Pub. Date: Aug. 4, 2005

(54) Automatic multimedia recording and reproduction system

(76) Inventors: Hiu Hung Sean Shek, Hong Kong (HK); Wai Shun Wilson Cheng, Hong Kong (HK)

Correspondence Address: Mr. Eric Chan, 42 Pin Oaks Drive, Phoenixville, PA, 19460, US

(21) Appl. No.: 10/773,955

(22) Filed: Jan. 31, 2004

(51) Int. Cl. G06F 17/60

(52) U.S. Cl. 705/41; 705/43

(57) ABSTRACT

The present invention relates to a system for application in an automatic vending machine for self-service recording and reproduction of sound and moving images on the spot in the format of video compact discs (VCDs), digital video discs (DVDs) or other recording discs, taking photo shots and printing photos or photo stickers with still images taken or from pre-recorded memory cards without the assistance of a photographer or technician. The automatic vending machine accepts different methods of payment and can be adapted to accept new forms of electronic payment and to apply new means of data recording and reproduction without changing other parts and components of the automatic vending machine.

### BACKGROUND OF THE INVENTION

The present invention relates to a multimedia recording and reproduction system and more particularly pertains to a system for application in an automatic vending machine for recording and reproduction of sound and moving images as well as still images.

Automatic vending machines for rapid production of photo stickers have been in popular use for many years. Such machines enable users to record and reproduce their images on photo stickers with the pre-selected foreground and/or background. A user can have photo stickers with his or her image in minutes without the assistance of a photographer or technician. The user simply enters a booth, inserts the required amount of money, selects the preferred foreground and/or background, poses before the camera and then waits for a few minutes to collect the photo stickers with his or her image printed on the stickers with the selected foreground and/or background. The photo stickers can be the user's own reminiscences of happy moments or special events or gifts to others. Such machines also enable a few users to record and reproduce their images together at one time so that the photo stickers can serve as reminiscences of special moments together. Usually, such booths are placed in locations in heavy traffic such as shopping malls and amusement parks. However, only still images can be recorded and reproduced. In remembrance of special moments or persons, it is preferable to record the sound and the moving images as well for vivid recollection in future.

Automatic vending machines for rapid production of passport photos can be described as the predecessor of those for producing photo stickers. The existing machines for producing passport photos do not provide any photo preview function. As a result, users are forced to have passport photos with which they are not satisfied or they have to pay the fees and retake the photos again. It can be costly and time-consuming to re-take until desired passport photos are produced. As the existing machines for producing passport photos can only produce passport photos in one standard size, users cannot choose to have photos of other sizes.

With the increased popularity of portable digital cameras, users may prefer to take photos with their own digital cameras. However, users may not have a color printer which can print high-quality photos at home. It is often inconvenient and time-consuming for users to go to traditional photo shops to print the photos. It would be more convenient to visit a booth nearby which can operate 24 hours a day to print the photos.

Therefore, an automatic multimedia recording and reproduction system is in need. The system can be structured as one or a plurality of automatic vending machine in a booth shape providing users with the convenience to produce photo stickers and passport photos of different sizes, to print photos or photo stickers of digital images from memory cards, and to record and reproduce recordings of sound and images in one single location without the assistance of a photographer or technician.

### BRIEF SUMMARY OF THE INVENTION

In view of the aforesaid disadvantages now present in the prior art, the present invention provides a system for application in a multipurpose automatic vending machine for recording and reproduction of sound and moving images as well as still images. It can record videos of sound and moving images and produce within minutes video compact discs (VCDs), digital video discs (DVDs) or any other format of recording discs which can hold digitized texts, photos, sound and/or videos. It can also record still images and produce photo stickers as well as passport photos. Furthermore, it can reproduce digital still or moving images which are stored in various memory cards. It enables users to produce photos, photo stickers and/or recording discs on the spot without the assistance of a photographer or technician.

To attain this, the present invention generally comprises a controlling and processing system, a payment handling system, a data storage system, a sound and image recording system, a reproduction and output system and a power supply system. The payment handling system, the data storage system, the sound and image recording system, the reproduction and output system and the power supply system are each connected to the controlling and processing system. The payment handling system, the sound and image recording system and the reproduction and output system are each connected to the power supply system. The controlling and processing system, the payment handling system, the data storage system, the sound and image recording system, the reproduction and output system and the power supply system are structured as an automatic vending machine in a booth shape.

The controlling and processing system comprises a central processing unit, one or more speakers and a display and control unit such as a control panel and a display monitor or a touch-screen monitor. The display and control unit and the speakers are each connected to the central processing unit. The central processing unit is installed with controlling and processing programming.

The payment handling system comprises one or more payment insert/output slots, a payment verification mechanism, an Internet connection device and a payment processing device. Payment can be made by coins, notes, tokens, credit cards or prepaid cards. The payment processing device is connected to the central processing unit.

The data storage system mainly comprises a memory device with pre-recorded texts, sound, photos, videos and computer programs that can be copied to the recording discs. The memory device is connected to the central processing unit.

The sound and image recording system comprises lights, blinds, a video camera, a memory card reader and a dispenser. The lights are for providing the necessary lighting for taking photos or recording videos. The blinds are for shutting out excessive light. The dispenser is for discarding empty recording discs and/or jewel cases for storing recording discs. The lights, the video camera, the memory card reader and the dispenser are connected to the central processing unit.

The reproduction and output system comprises a disc writer, an input/output tray for discarding or inserting recording discs, one or more color printers and one or more output slots for discarding photo stickers and/or passport photos irrespective of whether the still images are from memory cards or not. The input/output tray is connected to the disc writer and the disc writer is connected to the central processing unit. One of the output slots is connected to one of the color printers and the color printer is connected to the central processing unit. Other output slots are connected to other color printers and the color printers are connected to the central processing unit. The arrangement enables that one set of the output slot and the color printer connected thereto can be allocated to reproduce photo stickers and another set to reproduce passport photos.

The power supply system mainly comprises a power source and the electric circuit of the present invention. The power source supplies power to the controlling and processing system, the payment handling system, the sound and image recording system and the reproduction and output system.

To supply recording discs to users and to facilitate collection of payment for recording discs supplied, the present invention may incorporate a system for supplying specific recording discs for use. The system for supplying the specific recording discs can be structured as a separate automatic vending machine isolated from the automatic vending machine incorporating the controlling and processing system, the payment handling system, the data storage system, the sound and image recording system, the reproduction and output system and the power supply system. The system for supplying the specific recording discs may be connected to share the same power supply system or it may be connected to a separate power source.

The recording discs for use in the present invention are manufactured by using conventional method so that each recording disc has a specific digital signature which can be recognized by the central processing unit. The present invention records sounds and moving images only on the recording discs with the digital signature. Therefore, it can be ensured that all recording discs usable for the present invention are supplied from specific manufacturers. Users have to make payment to purchase the specific recording discs and cannot use other recording discs supplied in the marketplace.

The workflow of the present invention is as follows: Users make the requisite payment by inserting coins, notes, tokens, credit cards or prepaid cards into the appropriate payment insert/output slot. The payment verification mechanism and the payment processing device will then be activated. The payment processing device will give signals to the central processing unit and the central processing unit will activate the display and control unit which shows the payment instructions for the users to follow. If verification fails, the coins, notes, tokens, credit cards or prepaid cards will be slipped out from the payment insert/output slot for collection by the users. If verification succeeds, the payment processing device will conduct calculations, keep the coins, notes and tokens and leave the change, if any, in the payment insert/output slot for collection by the users. For credit card or prepaid card payments, verification and deduction will be conducted online through the Internet connection device. After finishing verification and deduction, the credit cards or prepaid cards will be slipped out from the payment insert/output slot. The users then follow the instructions as displayed on the display and control unit and press the buttons on the display and control unit to select the preferred operation mode such as taking passport photos, printing photos of images from memory cards, creating a video compact disc and photo stickers and so forth.

If a user selects the passport photo taking mode, the user can follow the instructions as displayed on the display and control unit to pose before the video camera, and press the buttons on the display and control unit to take a plurality of photo shots. Then, the user can select the preferred image from the number of photo shots taken and the preferred photo size. The central processing unit receives the signals and instructs the color printer to print a plurality of passport photos with the selected image of the selected size. The passport photos will then be dispensed to the predetermined output slot for collection by the user.

If a user selects to print photos of images from a memory card, the user can insert the memory card into the memory card reader. The display and control unit will then display the images stored in the inserted memory card. The user can then follow the instructions as displayed on the display and control unit and press the buttons on the display and control unit to select the images to be printed on photos. In the cases when the central processing unit is installed with computer programs which allows the users to edit the photos, for instance, to adjust the brightness or contrast, to add borders to the images and so forth, the user can follow the displayed instructions and press the buttons on the display and control unit to edit the photos. After the user has finished editing the photos, the user can follow the displayed instructions and press the buttons on the display and control unit to select the preferred photo size and to confirm the final edited version of the image to be printed. The central processing unit receives the signals and instructs the color printer to print the selected image of the selected size. The photos will then be dispensed to the predetermined output slot for collection by the user.

If a user selects to create a video recording disc and photo stickers, a recording disc with a specific digital signature and a jewel case for storing the recording disc are dispensed to the dispenser for collection by the user. The user then places the recording disc onto the ejected input/output tray. Then the user follows the instructions as displayed on the display and control unit and press the buttons on the display and control unit to preview and select the preferred pre-recorded texts, sound, photos and videos as the foreground and/or background to be printed on the photo stickers and recorded on the recording disc. The user can then follow the instructions as displayed on the display and control unit and pose before the video camera. The user can then press the buttons on the display and control unit to take photo shots and to select the preferred image and then to take a video, see the replay and confirm selection. The central processing unit receives the signals and will instruct the color printer to print the photo stickers and the disc writer to reproduce the recording disc. Depending on the predetermined configuration of the present invention, the central processing unit also instructs the disc writer to copy the pre-recorded computer programs stored in the data storage system to the recording disc. The computer program, for instance, can be a video email program which will automatically operate upon insertion of the recording disc into the CD-ROM of a personal computer and provide a user-friendly interface for the user to email the video recorded in the recording disc via the Internet to others. The photo stickers and the recording disc will then be dispensed to the respective output slots for collection by the user.

It is an object of the present invention to provide a system for application in a multipurpose multimedia automatic vending machine for self-service recording and reproduction of sound and moving images, taking of still images, producing photo stickers, passport photos and photos of preferred sizes as well as reproduction of still images or sound and moving images from pre-recorded memory cards.

It is another object of the present invention to provide an automatic vending machine which can rapidly record and reproduce sound and moving images on the spot in the format of video compact discs (VCDs), digital video discs (DVDs) or other recording discs without the assistance of a photographer or technician, thus overcoming the disadvantages of the prior art.

It is a further object of the present invention to provide an automatic vending machine which can accept different methods of payment and is capable of being changed to adapt to evolving new forms of electronic payment without changing other parts and components of the automatic vending machine, thus saving the replacement cost and time.

An even further object of the present invention is to provide an automatic vending machine which is capable of being changed to adapt to evolving new means of data recording and reproduction without changing other parts and components of the automatic vending machine, thus saving the replacement cost and time.

### BRIEF DESCRIPTION OF THE DRAWINGS

FIG. 1 shows the system linkage of the present invention.

FIG. 2 shows the inner layout of an embodiment of the present invention incorporated into an automatic vending machine.

FIG. 3 shows the outlook of an embodiment of the present invention incorporated into an automatic vending machine as illustrated in FIG. 2.

FIG. 4 shows the operation flowchart of the present invention in an automatic vending machine.

### DETAILED DESCRIPTION OF THE INVENTION

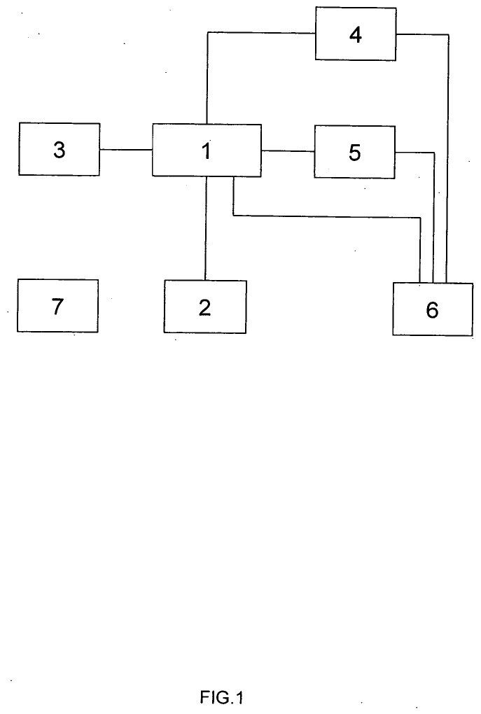

As illustrated in FIG. 1, the present invention generally comprises a controlling and processing system 1, a payment handling system 2, a data storage system 3, a sound and image recording system 4, a reproduction and output system 5, a power supply system 6 and a system for supplying specific recording discs 7. The payment handling system 2, the data storage system 3, the sound and image recording system 4, the reproduction and output system 5 and the power supply system 6 are each connected to the controlling and processing system 1. The payment handling system 2, the sound and image recording system 4 and the reproduction and output system 5 are each connected to the power supply system 6. The controlling and processing system 1, the payment handling system 2, the data storage system 3, the sound and image recording system 4, the reproduction and output system 5 and the power supply system 6 are structured as an automatic vending machine in a booth shape. The system for supplying the specific recording discs 7 is structured as an automatic vending machine isolated from automatic vending machine incorporating the controlling and processing system 1, the payment handling system 2, the data storage system 3, the sound and image recording system 4, the reproduction and output system 5 and the power supply system 6.

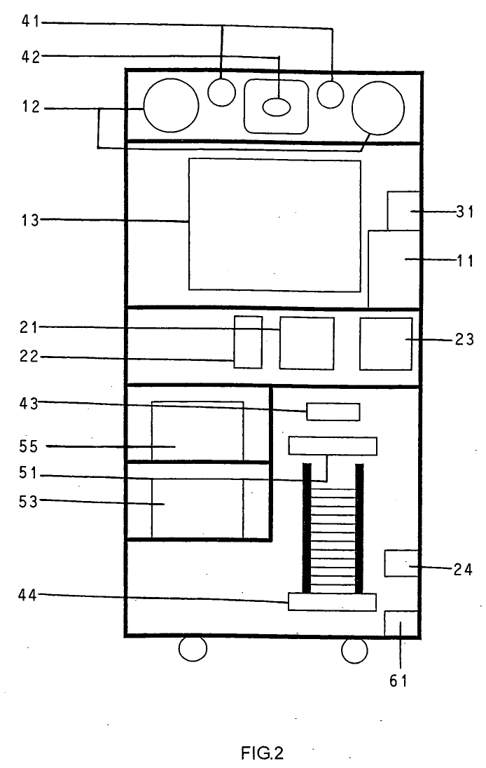

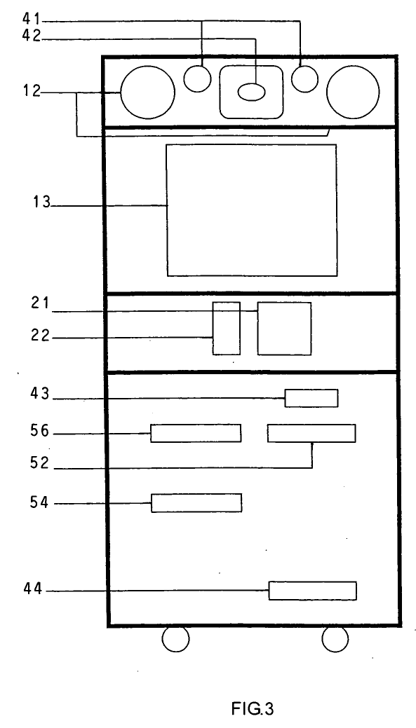

As illustrated in FIG. 2 and FIG. 3, the controlling and processing system 1 comprises a central processing unit 11, two speakers 12 and a touch-screen monitor 13. The two speakers 12 and the touch-screen monitor 13 are each connected to the central processing unit 11. The central processing unit 11 is installed with controlling and processing programming.

The payment handling system 2 comprises a note acceptor 21, a coin acceptor 22, a payment verification mechanism, an Internet connection device 24 and a payment processing device 23. Payment can be made by notes, tokens, credit cards or prepaid cards. The payment processing device 23 is connected to the central processing unit 11.

The data storage system 3 mainly comprises a memory device 31 with pre-recorded texts, sound, photos, videos and computer programs that can be copied to the recording discs. The memory device 31 is connected to the central processing unit 11.

The sound and image recording system 4 comprises lights 41, blinds (not shown), a video camera 42, a memory card reader 43 and a dispenser 44. The lights 41 are for providing the necessary lighting for taking photos or recording videos. The blinds are for shutting out excessive light. The dispenser 44 is for discarding empty recording discs and/or jewel cases for storing recording discs. The lights 41, the video camera 42, the memory card reader 43 and the dispenser 44 are each connected to the central processing unit 11.

The reproduction and output system 5 comprises a disc writer 51, an input/output tray 52 for discarding or inserting recording discs, an inkjet color printer 53, a photo stickers output slot 54, a thermal color printer 55, a photo output slot 56. The input/output tray 52 is connected to the disc writer 51 and the disc writer 51 is connected to the central processing unit 11. The photo stickers output slot 54 is connected to the inkjet color printer 53 and the inkjet color printer 53 is connected to the central processing unit 11. The photo output slot 56 is connected to the thermal color printer 55 and the thermal color printer 55 is connected to the central processing unit 11.

The power supply system 6 mainly comprises a power source 61 and the electric circuit of the present invention. The power source 61 supplies power to the controlling and processing system 1, the payment handling system 2, the sound and image recording system 4 and the reproduction and output system 5.

As illustrated in FIG. 2 and FIG. 3, the automatic vending machine can be in the form of an relatively enclosed chamber for users' privacy and for elimination of excess light and sound outside the chamber. It is to be placed in locations with power supply and the power source 61 of the automatic vending machine is connected to it. The central processing unit 11 in the automatic vending machine is installed with controlling and processing programming for operations. The memory device 31 is pre-recorded with texts, sound, photos and videos for selection as the foreground and/or background to be printed on the photo stickers as well as computer programs that can be recorded on the recording discs.

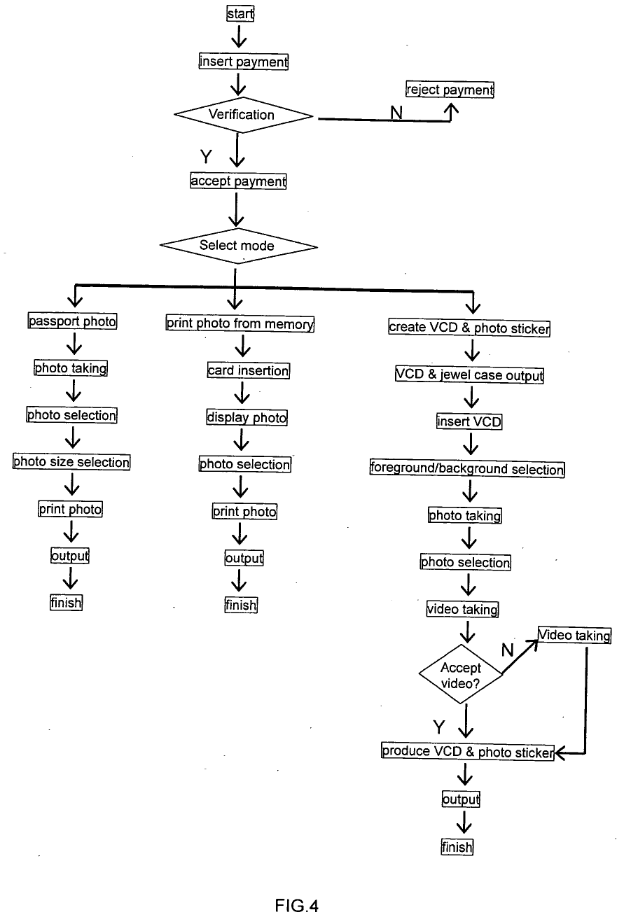

As illustrated in FIGS. 2 to 4, the present invention is operated in the following way:

1. A user enters the booth and inserts the requisite payment in the form of coins or notes into the note acceptor 21 or the coin acceptor 22. The payment verification mechanism and the payment processing device 23 are activated. The payment processing device 23 gives signals to the central processing unit 11 and the central processing unit 11 activates the touch-screen monitor 13, which shows the payment instructions for the user to follow. If verification fails, the coins or notes inserted will be slipped out from the note acceptor 21 or the coin acceptor 22 for collection by the user. If verification succeeds, the payment processing device 23 will conduct calculations, keep the coins or notes and leave the change, if any, in the note acceptor 21 or the coin acceptor 22 for collection by the user.

2. The user then follows the instructions as displayed on the touch-screen monitor 13 and presses the buttons shown on the touch-screen monitor 13 to select the preferred operation mode from one of the followings: (1) taking passport photos; (2) printing photos of images from a memory card; or (3) creating a video compact disc and photo stickers.

3. If the user selects to take passport photos, the user then follows the instructions as displayed on the touch-screen monitor 13 to pose before the video camera 42 and presses the buttons displayed on the touch-screen monitor 13 to take three photo shots. The user then selects the preferred image from the three photo shots taken and the preferred photo size. The central processing unit 11 receives the signals and instructs the thermal color printer 55 to print four passport photos with the selected image of the selected size. The passport photos will then be dispensed to the photo output slot 56 for collection by the user.

4. If the user selects to print photos of images from a memory card, the user then inserts the memory card into the memory card reader 43. The touch-screen monitor 13 then displays the images stored in the inserted memory card. The user then follows the instructions as displayed on the touch-screen monitor 13 and presses the buttons displayed on the touch-screen monitor 13 to select the image to be printed. The central processing unit 11 receives the signals and instructs the thermal color printer 55 to print the selected image. The photos will then be dispensed to the photo output slot 56 for collection by the user.

5. If the user selects to create a video compact disc and photo stickers, a video compact disc with a specified digital signature and a jewel case for storing the video compact disc are dispensed to the dispenser 44 for collection by the user. The user then places the video compact disc onto the ejected input/output tray 52. Then the user follows the instructions as displayed on the touch-screen monitor 13 and presses the buttons shown on the touch-screen monitor 13 to preview and select the preferred pre-recorded texts, sound, photos and videos as the foreground and/or background to be printed on the photo stickers and recorded on the video compact disc. The user then follows the instructions as displayed on the touch-screen monitor 13 and poses before the video camera 42. The user then presses the buttons displayed on the touch-screen monitor 13 to take photo shots and to select the preferred image to be printed on the photo stickers. The user then follows the instructions as displayed on the touch-screen monitor 13 and posses before the video camera 42. The user then presses the buttons displayed on the touch-screen monitor 13 to take a video. After recording, the user then presses the buttons displayed on the touch-screen monitor 13 to see the replay of the video taken and to confirm selection if the user is satisfied with the video. If the user is not satisfied with the first video taken, the user can press the buttons displayed on the touch-screen monitor 13 to take a second video and see the replay but the second video will be final and will be selected in any case. After photo taking and video recording, the central processing unit 11 instructs the inkjet color printer 53 to print the photo stickers and the disc writer 51 to reproduce the video compact disc. At the same time, the central processing unit 11 also instructs the disc writer 51 to copy the pre-recorded computer program to the video compact disc. In this embodiment, the computer program is a video email program which will automatically operate upon insertion of the video compact disc into the CD-ROM of a personal computer and provide a user-friendly interface for the user to email the video recorded in the recording disc via the Internet to others. The photo stickers are then dispensed to the photo stickers output slot 54 and the video compact disc is ejected from the input/output tray 56 for collection by the user.

As to a further discussion of the manner of usage and operation of the present invention, the same should be apparent from the above description. Accordingly, no further discussion relating to the manner of usage and operation is provided.

With respect to the above description, it is to be realized that the optimum relationships for the parts and components of the present invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

The present invention is capable of other embodiments and of being practiced and carried out in various ways. It is to be understood that the phraseology and terminology employed herein are for the purpose of description and should not be regarded as limiting.

Therefore, the foregoing is considered as illustrative only of the principles of the present invention. Further, since numerous modifications and changes will readily occur to those skilled in the art, it is not desired to limit the present invention to the exact construction and operation shown and described, and accordingly, all suitable modifications and equivalents may be resorted to falling within the scope of the present invention.

1. A system for application in an automatic vending machine for self-service recording and reproduction of sound and moving images on the spot in any format of recording discs, taking passport photo shots as well as printing photos of images from pre-recorded memory cards comprising:
a controlling and processing system;
a payment handling system;
a data storage system;
a sound and image recording system;
a reproduction and output system;
a power supply system;
and a system for supplying specific recording discs for use,
wherein the payment handling system, the data storage system, the sound and image recording system, the reproduction and output system and the power supply system are each connected to the controlling and processing system and the payment handling system, the sound and image recording system and the reproduction and output system are each connected to the power supply system; the controlling and processing system, the payment handling system, the data storage system, the sound and image recording system, the reproduction and output system and the power supply system are structured as an automatic vending machine in a booth shape; the system for supplying specific recording discs is structured as an automatic vending machine isolated from the automatic vending machine incorporating the controlling and processing system, the payment handling system, the data storage system, the sound and image recording system, the reproduction and output system and the power supply system.

2. A system as in claim 1, wherein the automatic vending machine accepts different methods of payment and can be adapted to accept new forms of electronic payment without changing other parts and components of the automatic vending machine.

3. A system as in claim 1, wherein the automatic vending machine can be adapted to apply new means of data recording and reproduction without changing other parts and components of the automatic vending machine.
